(19) United States
(12) Patent Application Publication
(10) Pub. No.: US 2024/0078576 A1
(43) Pub. Date: Mar. 7, 2024

(54) METHOD AND SYSTEM FOR AUTOMATED PRODUCT VIDEO GENERATION FOR FASHION ITEMS

(71) Applicants: RAJESH KUMAR SALIGRAMA ANANTHANARAYANA, BENGALURU (IN); SRIDHAR MANTHANI, BENGALURU (IN); VIGNESH KARNIKA, BENGALURU (IN)

(72) Inventors: RAJESH KUMAR SALIGRAMA ANANTHANARAYANA, BENGALURU (IN); SRIDHAR MANTHANI, BENGALURU (IN); VIGNESH KARNIKA, BENGALURU (IN)

(21) Appl. No.: 18/120,421

(22) Filed: Mar. 12, 2023

Related U.S. Application Data
(63) Continuation of application No. 17/873,099, filed on Jul. 25, 2022, now abandoned.
Application No. 17/873,099 is a continuation of application No. 17/668,541, filed on Feb. 10, 2022, now abandoned.
Application No. 17/668,541 is a continuation-in-part of application No. 16/533,767, filed on Aug. 6, 2019, now Pat. No. 11,783,408.
Application No. 16/533,767 is a continuation-in-part of application No. 16/294,078, filed on Mar. 6, 2019, now Pat. No. 11,188,790.
(60) Provisional application No. 62/714,763, filed on Aug. 6, 2018.
(60) Provisional application No. 62/639,359, filed on Mar. 6, 2018.

(51) Int. Cl. G06Q 30/0241; G06N 20/00; G06T 7/194; G06T 7/70

(52) U.S. Cl. CPC G06Q 30/0276; G06N 20/00; G06T 7/194; G06T 7/70

(57) ABSTRACT

A method for an automated video generation from a set of digital images includes the step of obtaining the set of digital images. The set of digital images represent a specified object to be showcased in an automatically generated video. The method includes the step of implementing pose identification on each view of the specified object in the set of digital images. The method includes the step of implementing a background removal operation to set a consistent background to each digital image. The method includes the step of implementing an image resolution increase operation on each digital image. The method includes the step of implementing an attribute extraction operation on each digital image using a set of image classifiers. The set of image classifiers are run on each digital image to generate one or more textual tags. The one or more textual tags are integrated in the automatically generated video; The method includes the step of implementing an attention map generation. An attention map comprises a visualization of the specified object produced by a deep-learning algorithm that determines a most influential part of each digital image. A predicted tag specifying the most influential part each digital image, where each attention maps is used in the automatically generated video to zoom into specific areas of the object. The method includes the step of implementing an outfit generation of a collage of images of the specified object with other objects, wherein the collage of images is included in the automatically generated video to show various combinations of the specified object and other object. The method includes the step of generating a rendering of the automatically generated video comprising the set of digital images with the consistent background, an increased resolution, the one or more contextual tags, one or more zooms into specified areas a specified object and the collage of images.

### CLAIM OF PRIORITY

This application claims the benefit of U.S. patent application Ser. No. 16/294,078 filed on Mar. 6, 2019, and entitled “Use of Virtual Reality to Enhance the Accuracy in Training Machine Learning Models” which is incorporated by reference herein.

This application claims the benefit of U.S. Provisional Patent Application No. 62/639,359 filed on Mar. 6, 2018, and entitled “Use of Virtual Reality to Enhance the Accuracy in Training Machine Learning Models” which is incorporated by reference herein.

### BACKGROUND

### Field of the Invention

The present invention is in the field of machine learning and more particularly to the generation of datasets for training of machine learning systems.

### Related Art

Videos are increasingly becoming the most preferred media for marketers. Products with videos are known to provide higher conversions since it adds a lot of trust and value to the product being sold. Unfortunately, creating videos can be a difficult tasks that can require a great deal of skill and specific software tools.

In the fashion domain, each fashion season include lots of new products. With fast fashion, seasons can change every week. Product development in fashion can involve a lot of nuance in the design. A shirt may be structurally the same as another shirt, but it can vary in color print, neckline, sleeve, fit etc. These variations are created by the designer. Hence, it is important for the video generation platform to also identify these nuances and uniqueness of the product and showcase the same.

### SUMMARY OF THE INVENTION

A method for an automated video generation from a set of digital images includes the step of obtaining the set of digital images. The set of digital images represent a specified object to be showcased in an automatically generated video. The method includes the step of implementing pose identification on each view of the specified object in the set of digital images. The method includes the step of implementing a background removal operation to set a consistent background to each digital image. The method includes the step of implementing an image resolution increase operation on each digital image. The method includes the step of implementing an attribute extraction operation on each digital image using a set of image classifiers. The set of image classifiers are run on each digital image to generate one or more textual tags. The one or more textual tags are integrated in the automatically generated video; The method includes the step of implementing an attention map generation. An attention map comprises a visualization of the specified object produced by a deep-learning algorithm that determines a most influential part of each digital image. A predicted tag specifying the most influential part each digital image, where each attention maps is used in the automatically generated video to zoom into specific areas of the object. The method includes the step of implementing an outfit generation of a collage of images of the specified object with other objects, wherein the collage of images is included in the automatically generated video to show various combinations of the specified object and other object. The method includes the step of generating a rendering of the automatically generated video comprising the set of digital images with the consistent background, an increased resolution, the one or more contextual tags, one or more zooms into specified areas a specified object and the collage of images.

### BRIEF DESCRIPTION OF THE DRAWINGS

FIG. 1 is a schematic representation of an exemplary hardware environment, according to some embodiments.

FIG. 2 schematically illustrates a method for generating a synthetic dataset, according to some embodiments.

FIG. 3 is a flowchart representation of a method of the present invention for producing a dataset of images and/or videos for training or validating deep learning models, according to some embodiments.

FIGS. 4A-4D illustrate, in order, a 3D design 230 for target garment, a 3D design for a human in an exemplary pose, a fabric design as an exemplary parameter of the 3D design for the target garment, and a rendered image of the human model wearing the garment model in the scene model, according to some embodiments.

FIG. 5 is a flowchart representation of a method of the present invention for producing a dataset of images and/or videos for training or validating deep learning models.

FIG. 6 illustrates an example process for implementing an automated product video generation for fashion items with a streaming and analytics platform, according to some embodiments.

FIG. 7 illustrates another example process for automated product video generation for fashion items, according to some embodiments.

FIG. 8 depicts an exemplary computing system that can be configured to perform any one of the processes provided herein.

FIGS. 9-15 illustrate an example set of screen shots illustrating automated product video generation for fashion items, according to some embodiments.

FIG. 16 illustrates another example automated product video generation process according to some embodiments.

The Figures described above are a representative set and are not an exhaustive with respect to embodying the invention.

### DESCRIPTION

Disclosed are a system, method, and article of manufacture of an automated product video generation for fashion items. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Attention map can be a scalar matrix representing the relative importance of layer activations at different 2D spatial locations with respect to the target task. An attention map can be a grid of numbers that indicates what two-dimensional locations are important for a task. Important locations ca correspond to bigger numbers (e.g. can be depicted in red in a heat map.

Cloud computing can involve deploying groups of remote servers and/or software networks that allow centralized or decentralized data storage and elastic online access (meaning when demand is more, more resources will be deployed and vice versa) to computer services or resources. These groups of remote servers and/or software networks can be a collection of remote computing services.

Fuzzy logic is a superset of Boolean logic that has been extended to handle the concept of partial truth such that there are truth values between completely true and completely false. Fuzzy logic ML can use fuzzification processes, inference engines, defuzzification processes, membership functions, etc.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

TensorFlow is a free and open-source software library for machine learning. It can be used across a range of tasks but has a particular focus on training and inference of deep neural networks. TensorFlow is a symbolic math library based on dataflow and differentiable programming.

Example Methods and Systems

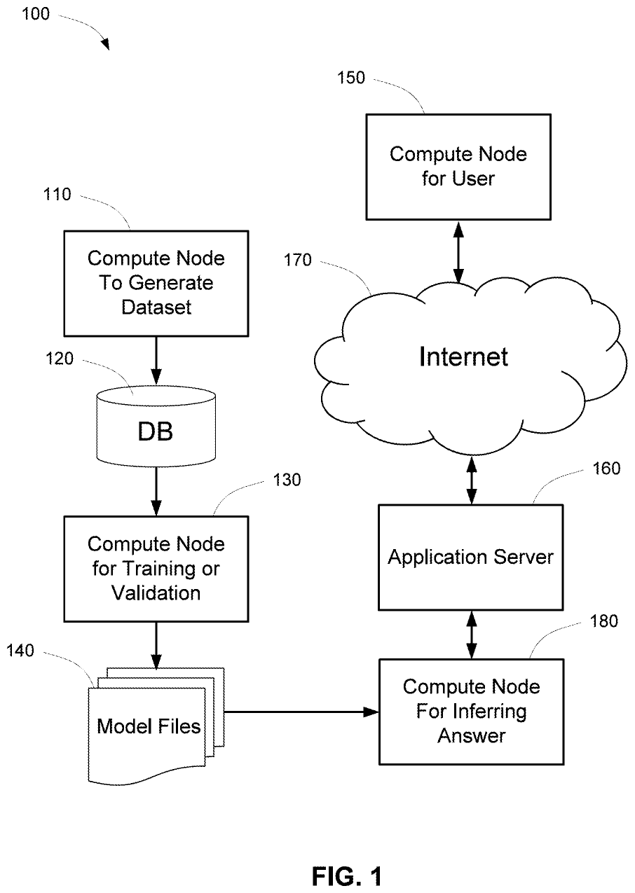

FIG. 1 is a schematic representation of an exemplary hardware environment 100, according to some embodiments. The hardware environment 100 includes a first compute node 110 that is employed to generate synthetic images and/or synthetic video to build a dataset. In various embodiments the compute node 110 is a server but can be any computing device with sufficient computing capacity such as a server, personal computer, or smart phone. The compute node 110 can optionally add non-synthetic, i.e., real-world images and/or video to the dataset. The compute node 110 stores the dataset to a database 120. A second compute node 130, which can be the same compute node as first compute node 110, in some embodiments, accesses the database 120 in order to utilize the dataset to train deep learning models to produced trained model files 140. The second compute node 130 can optionally also validate deep learning models.

A user employing a third compute node 150 can upload an image or video, including a target therein, to an application server 160 across a network like the Internet 170, where the application server 160 hosts a search engine, for example a visual search engine or recommendation engine, or an application like an automatic image tagging application. In response to a request from the compute node 150, such as a mobile phone or PC, to find information on the target, such as a garment, a hat, a handbag, shoes, jewelry, etc., or to locate similar products, or to tag the image, the application server 160 connects the third compute node 150 to a fourth compute node 180, which can be the same compute node as either the first or second compute nodes 110, 130, in some embodiments. Compute node 180 uses the model files 140 to infer answers to the queries posed by the compute node 150 and transmits the answers back through the application server 160 to the compute node 150.

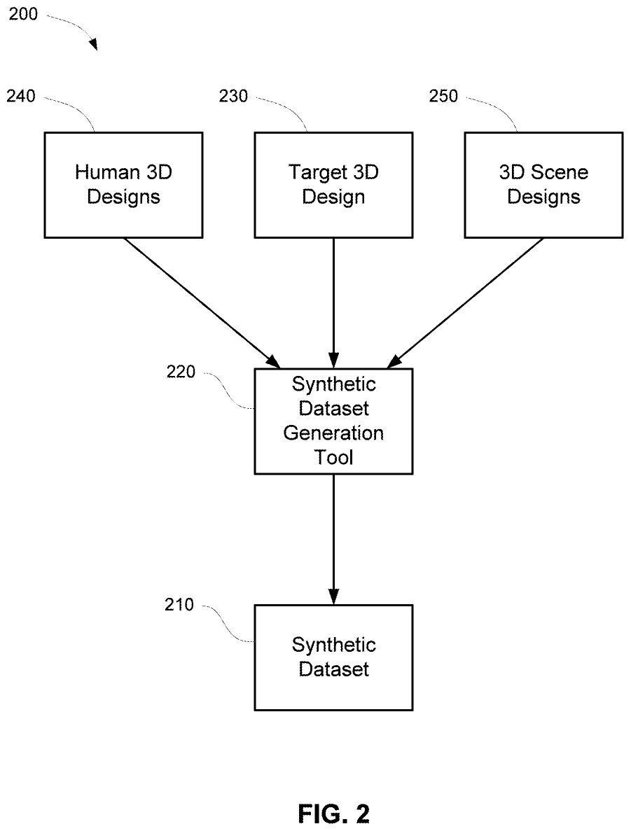

FIG. 2 schematically illustrates a method 200 for generating a synthetic dataset 210, according to some embodiments. The synthetic dataset 210 is generated by a synthetic dataset generation tool 220 that receives, as input, one or more 3D designs 230 for targets, a plurality of 3D designs 240 for humans, and a number of 3D designs 250 for scenes. The generation tool 220 runs on compute node 110, in some embodiments. The terms “3D design” and “3D model” are used synonymously herein. The various 3D designs 230, 240, 250 can be obtained from the public sources over the Internet or from private data collections and stored in libraries such as in database 120 or another storage.

The generation tool 220 takes a 3D design 230 for a target, such as a garment, and combines it with a human 3D design from the plurality of 3D designs 240, and sets the combination in a 3D scene from the number of 3D designs 250. The generation tool 220 optionally also varies parameters that are made available by the several 3D designs 230, 240, 250 to populate the synthetic dataset 210 with a large number of well characterized examples for training a deep learning model or for validating an already trained deep learning model. In some embodiments, specific combinations of 3D designs 230, 240, 250 are selected to represent situations in which an already trained deep learning model is known to perform poorly.

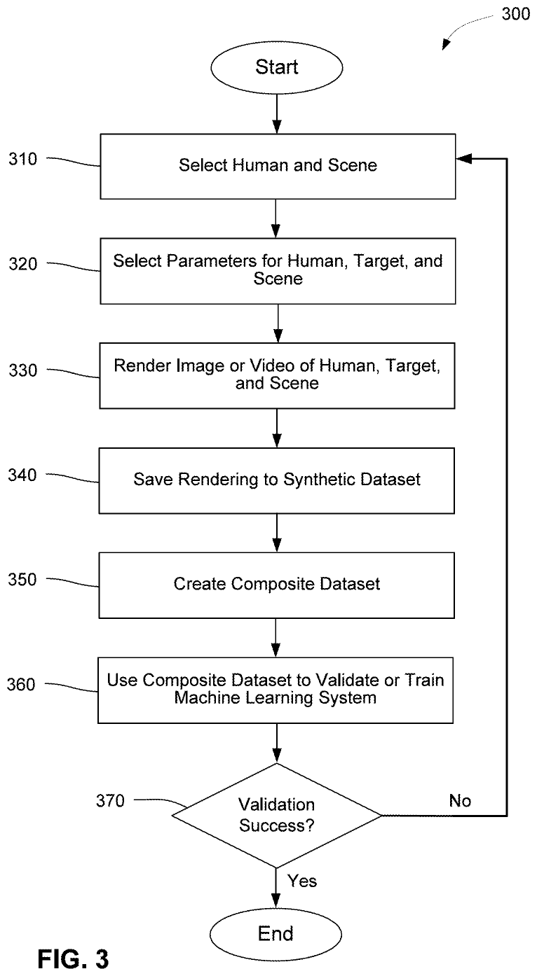

FIG. 3 is a flowchart representation of a method 300 of the present invention for producing a dataset of images and/or videos for training or validating deep learning models, according to some embodiments. The method 300 can be performed, for example, by first compute node 110 running generation tool 220, in some embodiments. The method 300 applies to a given target, such as a garment, on which the training dataset is centered. While the method 300 is described with respect to a single target, in practice multiple targets can be processed simultaneously to create synthetic datasets 210 for each target, or a synthetic dataset 210 for all targets. Example dataset can be for image tagging where in an image is associated with one or more textual tags. Dataset for object detection where an image is associated with bounding boxes localizing the garment. Dataset for image segmentation where an images with associated with pixel level mapping of fashion items. Datasets for many such machine learning tasks.

In a step 310 a 3D design 230 for a target is received or produced, for example an object file for a garment, and a 3D design 240 for a human is selected from the 3D designs 240 for humans and a 3D design 250 for a scene is selected from the 3D designs 250 for scenes, also as object files. A 3D design 230 can be provided by a user of the method 300, for example by selecting the 3D design 230 from a library, or by designing the 3D design 230 with commercially available software for designing garments. An example of a utility for creating 3D designs 240 for humans is Blender. In other embodiments, the 3D design 230 is selected from a library based on one or more values of one or more parameters. For instance, to produce a synthetic dataset for further training a trained deep learning model to improve the model for garments that are made from certain fabrics, a 3D design 230 for a garment can be selected from a library based on the availability of one of those fabrics within the fabric choices associated with each 3D design 230.

In some embodiments, the selections of both the 3D design 240 for the human and the 3D design 250 for the scene are random selections from the full set of available choices. In some instances, meta data associated with the target limits the number of possibilities from the 3D designs 240 for humans and/or 3D designs 250 for scenes. For example, meta data specified by the object file for the target can indicate that the garment is for a woman and available in a limited range of sizes, and as such only 3D designs 240 of women in the correct body size range will be selected.

In other embodiments the 3D design 240 for a human and the 3D design 250 for a scene are purposefully selected, such as to train an existing deep learning model that is known to perform poorly under certain circumstances. In these embodiments a synthetic dataset 210 of images and/or videos is produced that are tailored to the known weakness of the existing deep learning model. For example, a deep learning model is trained to recognize a jumpsuit, but if during validation an image including the jumpsuit is given to the model and the model fails to recognize the jumpsuit, that instance will be flagged as a mistake. Ideally, the model is further trained to better recognize the jumpsuit, but using only this flagged image for the further training will not meaningfully impact the model's accuracy. To properly further train the model, the flagged image is sent to the synthetic dataset generation tool 220 to generate many additional synthetic images or video that are all similar to the flagged image.

In some embodiments, the synthetic dataset generation tool 220 is configured to automatically replicate the flagged image as closely as possible given the various 3D models available. In these embodiments the synthetic dataset generation tool 220 is configured to automatically select the closest 3D model to the target jumpsuit, select the closest 3D scene to that in the flagged image, and select the closest human 3D model to that shown in the flagged image.

In a step 320 values for various variable parameters for the target and the selected 3D human designs 230, 240 and selected 3D scene design 250 are further selected. For the 3D design 240 of the human these parameters can include such features as pose, age, gender, BMI, skin tone, hair color and style, makeup, tattoos, and so forth, while parameters for the 3D design 230 can include texture, color, hemline length, sleeve length, neck type, logos, etc. Object files for the selected 3D models 230, 240, 250 can specify the available parameters and the range of options for each one; above, an example of a parameter is type of fabric, where the values of the parameter are the specific fabrics available. Parameters for the 3D scene 250 can include lighting angle and intensity, color of the light, and location of the target with the human within the scene. Thus, if fifty (50) poses are available to the selected 3D design 240 for a human, in step 320 one such pose is chosen. As above, values for parameters can be selected at random, or specific combinations can be selected to address known weaknesses in an existing deep learning model. The synthetic dataset generation tool 220, in some embodiments, automatically selects values for parameters for the several 3D models, such as pose for the human 3D model. In some embodiments, a user of the synthetic dataset generation tool 220 can visually compare a synthetic image or video automatically produced to the flagged image or video and optionally make manual adjustments to the synthetic image or video. With this synthetic image or video as a starting point, small variations in the human 3D model and the 3D scene model and the values of the various parameters used by the 3D models can be made in successive iterations to produce still additional synthetic images or videos to populate a synthetic dataset for further training.

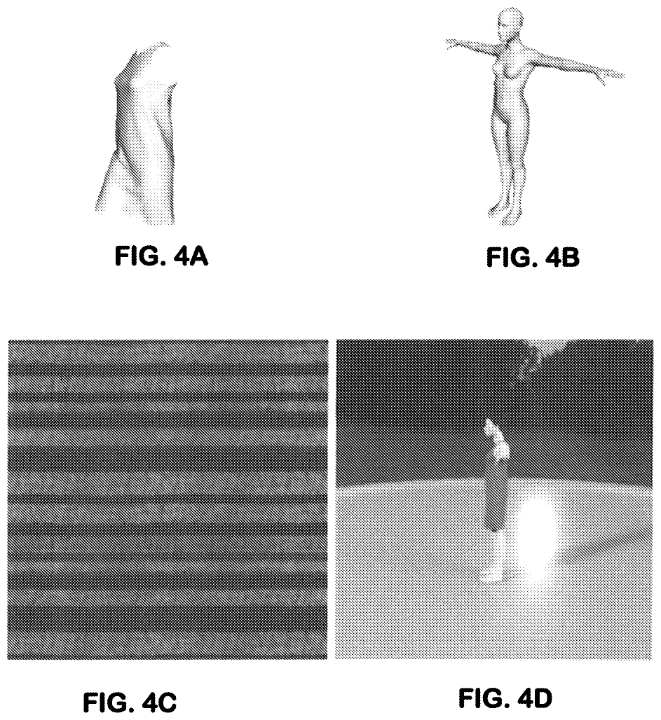

In a step 330 an image or video is rendered of the target with the human set in the scene. FIGS. 4A-4D illustrate, in order, a 3D design 230 for target garment, a 3D design 240 for a human in an exemplary pose, a fabric design as an exemplary parameter of the 3D design 230 for the target garment, and a rendered image of the human model wearing the garment model in the scene model. In these examples, polygon meshes are employed for the garment and human 3D designs but any of the 3D designs noted herein can also be represented polygon tables or plane equations as well.

In a step 340 the rendered image is saved as a record to a synthetic dataset. Examples of suitable rendering software includes those available through Blender and Houdini. Each such record includes the values of the parameters that were used to create it. Such information serves the same function in training as image tags in a tagged real-world image. By repeating the steps 310-340 many times, an extensive library can be developed of images or videos of the same target or targets in varied contexts. In some embodiments, all selections are under the manual control of a user through a user interface.

In an optional step 350 a composite dataset is created by merging the synthetic dataset with tagged real-world images or videos. The real-world images or videos can be sourced from the Internet, for example, and tagged by human taggers. Examples of real-world videos include fashion ramp walk videos and fashion video blogger videos. In some embodiments, a suitable composite dataset includes no more than about 90% synthesized images and at least about 10% real-world images with image tags.

In an optional step 360 the composite dataset is used to train or validate a machine learning system. Training of a deep learning model can be performed, for example, using a commercially available deep learning framework such those made available by TensorFlow, caffe, MXNet, and Torch, etc. The framework is given a configuration that specifies a deep learning architecture, or a grid search is done where the framework trains the deep learning model using all available architectures in the framework. This configuration has the storage location of the images along with their tags or synthesis parameters. The framework takes these images and starts the training. The training process is measured in terms of “epochs.” The training continues until either convergence is achieved (validation accuracy is constant) or a stipulated number of epochs is reached. Once the training is done, the framework produces a model file 140 that can be used for making inferences like making predictions based on query images.

To validate a machine learning system in step 360, the machine learning system is given images from the dataset to see how well the machine learning system characterizes the images, where performance is evaluated against a benchmark. The result produced for each image provided to the machine learning system is compared to the values for the parameters, or image tags, in the record for that image to assess, on an image-by-image basis, whether the machine learning system was correct. A percentage of correct outcomes is one possible benchmark, where the machine learning system is considered validated if the percentage of correct outcomes equals or exceeds the benchmark percentage. If the machine learning system fails the validation, at decision 370, the images that the machine learning system got wrong can be used to further train the machine learning system and can be used as bases for further synthetic image generation for the same, looping back to step 310.

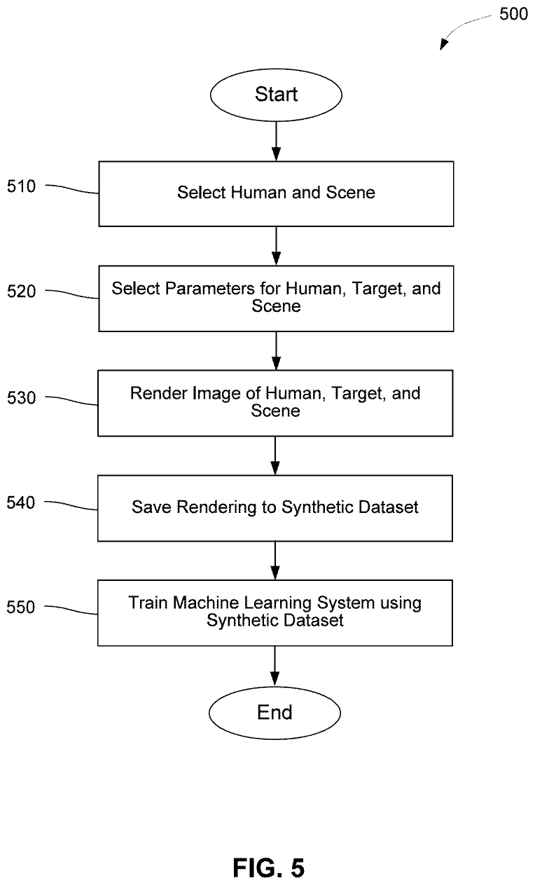

FIG. 5 is a flowchart representation of a method 500 of the present invention for producing a dataset of images and/or videos for training or validating deep learning models, according to some embodiments. Steps 510-540 correspond to steps 310-340 of method 300. Instead of adding non-synthetic images or videos, as in method 300, in method 500 only the synthetic images or videos are used. The synthetic dataset is used to train a machine learning system in a step 550. One can use method 500 where an existing machine learning system fails a validation. For example, if a machine learning system fails a validation using real-world tagged images or videos, the particular images that the machine learning system got wrong can be simulated by selecting values for parameters in step 520 that will closely approximate, or simulate, the images that the machine learning system got wrong. Such simulated synthetic images can differ in small ways, one from the next.

The descriptions herein are presented to enable persons skilled in the art to create and use the systems and methods described herein. Various modifications to the embodiments will be readily apparent to those skilled in the art, and the generic principles defined herein may be applied to other embodiments and applications without departing from the spirit and scope of the inventive subject matter. Moreover, in the following description, numerous details are set forth for the purpose of explanation. However, one of ordinary skill in the art will realize that the inventive subject matter might be practiced without the use of these specific details. In other instances, well known machine components, processes and data structures are shown in block diagram form in order not to obscure the disclosure with unnecessary detail. Identical reference numerals may be used to represent different views of the same item in different drawings. Flowcharts in drawings referenced below are used to represent processes. A hardware processor system may be configured to perform some of these processes. Modules within flow diagrams representing computer implemented processes represent the configuration of a processor system according to computer program code to perform the acts described with reference to these modules. Thus, the inventive subject matter is not intended to be limited to the embodiments shown, but is to be accorded the widest scope consistent with the principles and features disclosed herein.

The foregoing description and drawings of embodiments in accordance with the present invention are merely illustrative of the principles of the invention. Therefore, it will be understood that various modifications can be made to the embodiments by those skilled in the art without departing from the spirit and scope of the invention. The use of the term “means” within a claim of this application is intended to invoke 112(f) only as to the limitation to which the term attaches and not to the whole claim, while the absence of the term “means” from any claim should be understood as excluding that claim from being interpreted under 112(f). As used in the claims of this application, “configured to” and “configured for” are not intended to invoke 112(f).

Automated Product Video Generation

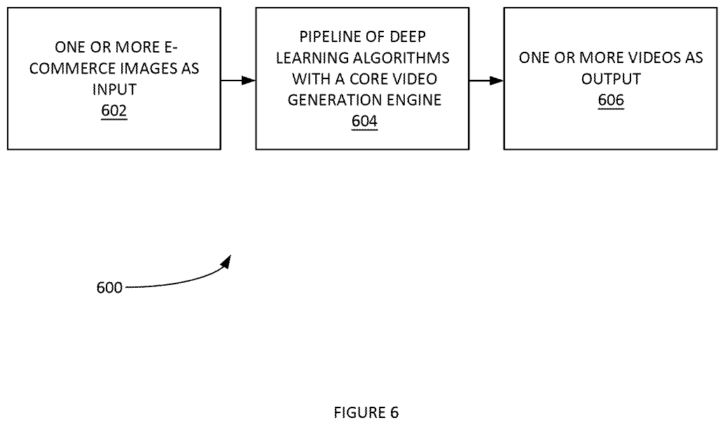

FIG. 6 illustrates an example process 600 for implementing an automated platform for video generation for fashion items with a streaming and analytics platform, according to some embodiments. In step 602, the automated platform for video generation for fashion items receives as input a one or more digital images.

In step 604, the automated platform for video generation for fashion items is implemented as a pipeline that includes a core video generation engine. The video generation engine utilizes various deep learning algorithms. The engine takes input from deep learning algorithms and come up with a video. For example, in order to showcase a product attribute, the video generation engine takes an attention map as an input along with a tag. The video generation engine can then zoom into the area specified in the attention map. In step 606, the automated platform for video generation for fashion items output one or more videos as output. In another example, process 600 can use deep learning algorithms to choose the best pose and the best background wherein we use image segmentation algorithms to standardize the background automatically.

Process 600 can showcase an entire catalog of digital images by showing some of the combinations (e.g. outfits) that the input product can be part of. Also, process 600 can showcase the catalog by comparing the input product to other products in the catalog. Process 600 has an ability to consider viewer's personal preferences and create a personalized interactive video.

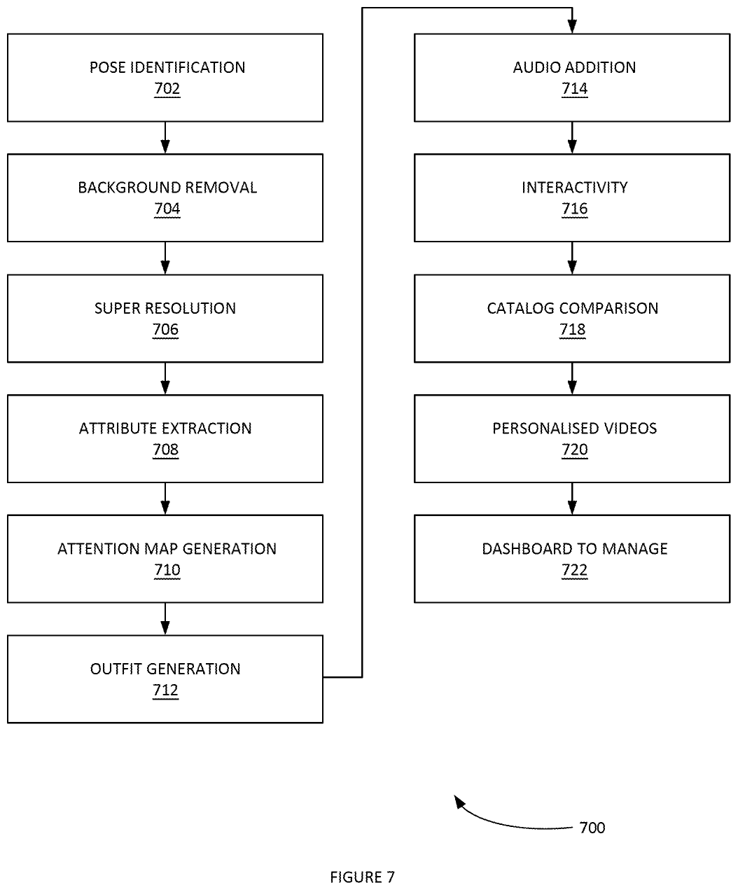

FIG. 7 illustrates another example process 700 for automated product video generation for fashion items, according to some embodiments.

In step 702, process 700 can implement pose identification. For example, given an image as an input to the system, process 700 can determine whether it is a front pose, side pose or flat (ghost) shot. Based on the type of image, the system can then be able to decide which video template to pick.

In step 704, process 700 can implement background removal. The video can be provided a consistent background. In order to ensure clean aesthetics, process 700 can clean out the background color and make it a PNG with transparent background.

In step 706, process 700 can implement super resolution. The images given to the system can be of any size. The video can be made to focus on specific details in a garment. Process 700 can thus provide that the resolution is high. With high resolution, even smaller resolution images can be accepted.

It is noted that steps 702-706 can be part of a digital image pre-processing phase. Accordingly, other digital image pre-processing functions and processes can be implemented as well.

In step 708, process 700 can implement attribute extraction. Process 700 can utilize a set of image classifiers. The set of image classifiers can be run on the input digital image in order to obtain all the textual tags. These textual tags can be used in the video. The contextual tags can also be used to provide nuance in a product. A contextual tag can be a term(s) assigned to a piece of information about the product. The digital video can also highlight the rare and unique features of the product.

It is noted that image processing and/or machine vision algorithms can be utilized herein. Image processing can be used to determine whether or not the image data contains some specific object, feature, or activity. Example functionalities can include, inter alia: object recognition/object classification (e.g. one or several pre-specified or learned objects or object classes can be recognized, usually together with their 2D positions in the image or 3D poses in the scene); identification (e.g. an individual instance of an object is recognized); detection (e.g. the image data are scanned for a specific condition); etc. Process 700 can implement, inter alia: content-based image retrieval, optical character recognition, 7D code reading, facial recognition, shape recognition technology (SRT), motion analysis, etc.

In step 710, process 700 can implement attention map generation. Attention maps can be visualizations produced by deep-learning algorithms to showcase which part of the image was most influential in order to obtain the predicted tag. The attention maps can be used in the video generation to zoom into specific areas and specify the tag.

In step 712, process 700 can implement outfit generation (e.g. collage image generation). Process 700 can cause the video to show various combinations (e.g. outfit combinations) that the fashion product can be a part of. Process 700 can use an image-type detector to identify the pose of the model wearing the product. Based on the pose (and/or whether it's a ghost image), process 700 can consider an appropriate collage which can have a best aesthetic (e.g. based on specified factors/parameters). The collage image generator can also minimize the white space between the product images.

In step 714, process 700 can provide audio addition. The video generation platform can also select relevant audio as a background score. This audio can be based on the aesthetics of the product and choose appropriately.

In step 716, process 700 can implement various interactivity steps. The video generation platform can add hooks in the video where video can become interactive. Hooks can be links to other products presented in the video. Hooks can also include hyperlinks to coupons and discounts/promotions.

In step 718, process 700 can implement catalog comparison operations. The video generation engine can also compare the given product with other products and produce animations that depict the uniqueness of the given product. It can also give a basic overview of the rest of catalog.

In step 720, process 700 can implement personalized videos. The video generation platform actually generates an array of short (e.g. n-second, three (3), etc.) second videos. These short videos can be animations. Each animation can be related to each attribute of an outfit. The final rendering can consider certain parameters that are most appealing to the viewer and dynamically change the rendering to give different videos. Some of the parameters of consideration can be geographic locations, viewer age and/or other demographic details of the viewer. This can also be implemented with a personal-closet application as well.

In step 722, process 700 can implement a dashboard to manage the video generation platform. In one example, a dashboard can be provided that allows video editing. It is noted that the video generation process can include use of various deep-learning algorithms. Accordingly, there can be a probability that either super resolution and/or attribute extraction and/or outfit generation may result in a non-optimal video. In order to counter this, the dashboard can be provided and the user can use the dashboard to correct various aspects of the automatically generated video. The dashboard also allows users (e.g. video creators) to embed some links and make the videos interactive.

Example Systems

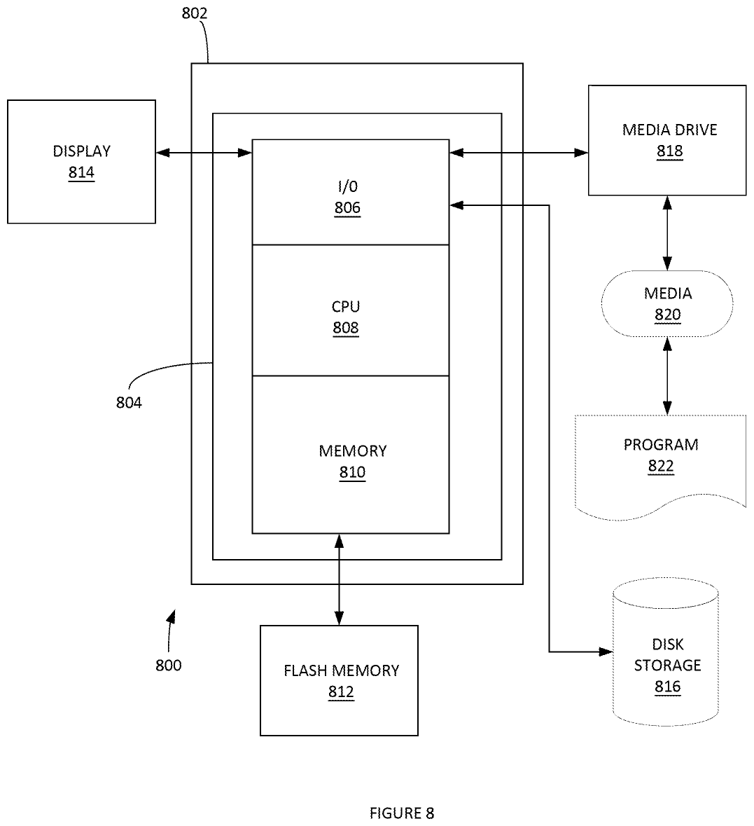

FIG. 8 depicts an exemplary computing system 800 that can be configured to perform any one of the processes provided herein. In this context, computing system 800 may include, for example, a processor, memory, storage, and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform any of the processes described herein. The main system 802 includes a motherboard 804 having an I/O section 806, one or more central processing units (CPU) 808, and a memory section 810, which may have a flash memory card 812 related to it. The I/O section 806 can be connected to a display 814, a keyboard and/or other user input (not shown), a disk storage unit 816, and a media drive unit 818. The media drive unit 818 can read/write a computer-readable medium 820, which can contain programs 822 and/or data. Computing system 800 can include a web browser. Moreover, it is noted that computing system 800 can be configured to include additional systems in order to fulfill various functionalities. Computing system 800 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Screen Shots and Use Cases

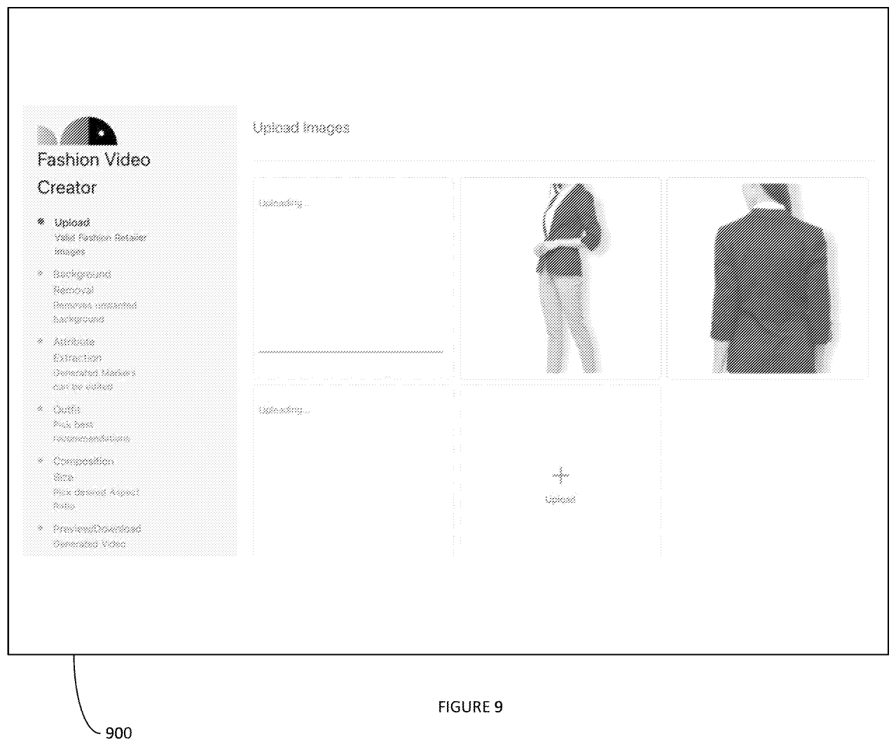

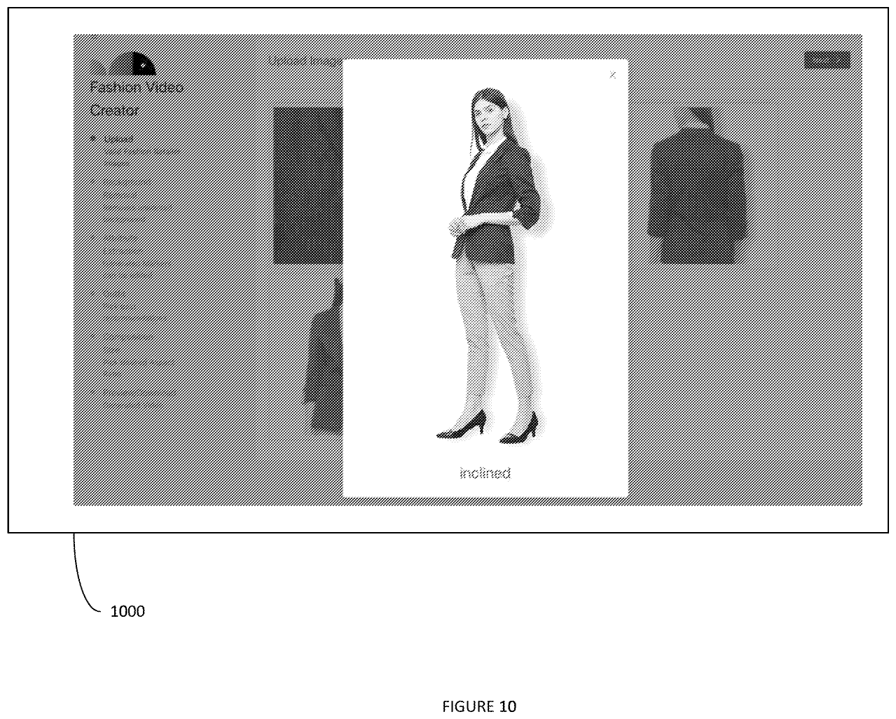

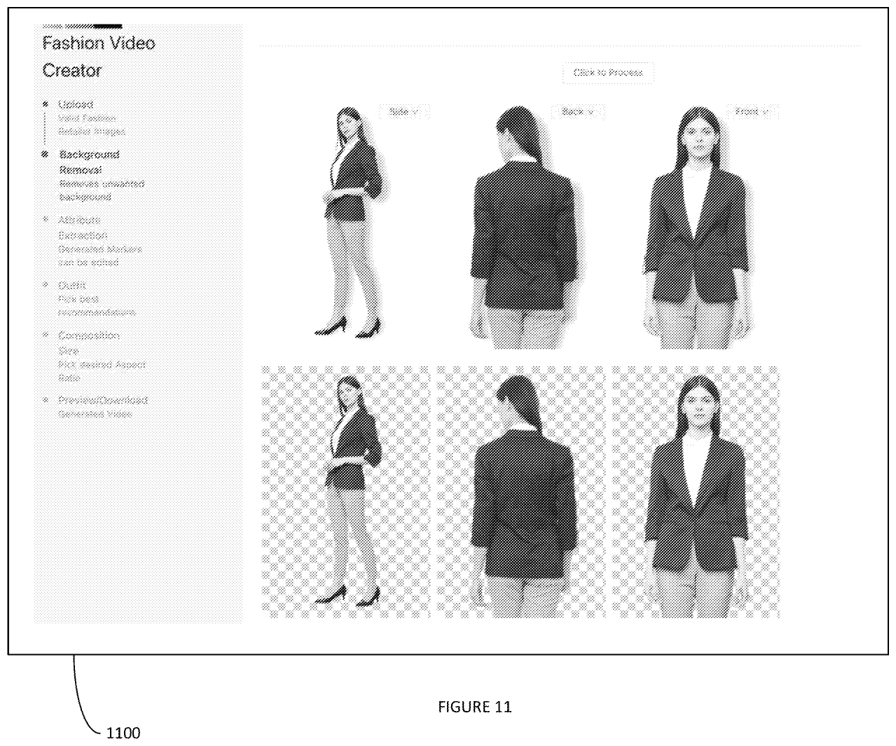

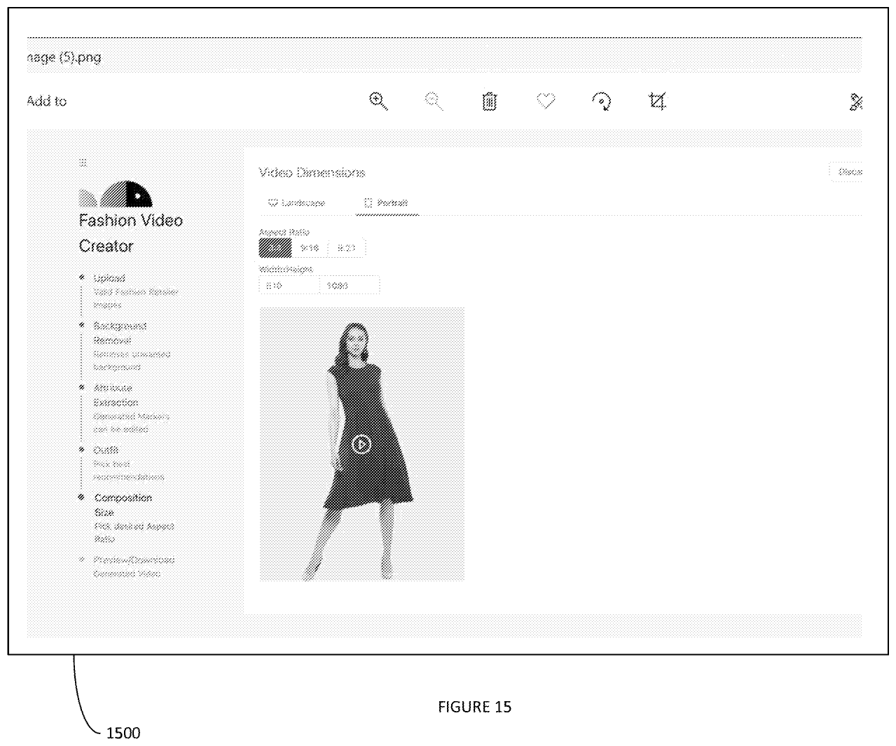

FIGS. 9-15 illustrate an example set of screen shots 900-1500 illustrating automated product video generation for fashion items, according to some embodiments. The left-hand side of the screen shots provides a list of steps of automated product video generation process. Each screen shot indicates to a view what step of the automated product video generation process is being performed.

Screen shot 900 shows a set of digital images of a product or other item that is to be included in the automated product video. As shown, user's can upload a set of digital images showing various views/aspects of a fashion item(s) to be included in the automatically generated video. Screen shot 1000 shows a screen shot of a user selecting attributes for the uploaded digital images.

Screen shot 1100 shows an example background removal process where unwanted background effects are removed. It is noted that ML algorithms can be utilized to automate the background removal step (e.g. see process 1600 infra).

Screen shots 1200 and 1300 shows examples of attribute extraction. As shown, automatically-generated markers (e.g. using ML) can be edited to ensure correct output. A human can correct/delete incorrectly extracted attributes. Attributes can be located on the fashion item (e.g. ‘long sleeves’ attribute on the long sleeve of a jacket, etc.)

Screen shot 1400 shows a means by which a user can perform outfit selection. For each outfit, a user can view one or more videos of the fashion items generated by automated product video generation process 1600.

Screen shot 1500 shows a webpage where composition size (e.g. aspect ratios, etc.) are selected for the generated video. A user can select a combination of fashion items for an outfit. A video of the outfit can be generated. For example, if a jacket is being promoted, other products relevant to a jacket can be selected for the jacket model. These can be automatically selected by a fuzzy logic ML and then corrected by an expert if needed.

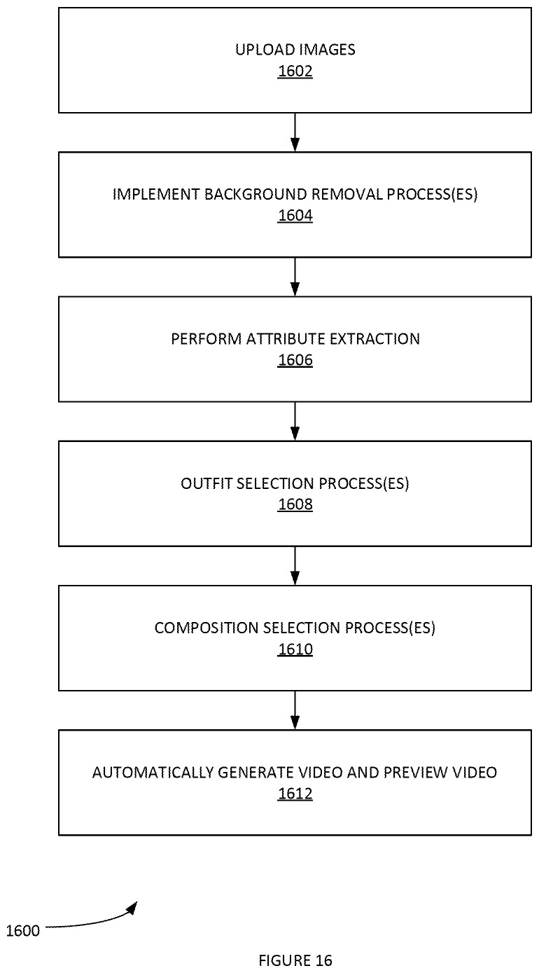

FIG. 16 illustrates another example automated product video generation process 1600 according to some embodiments. Process 1600 can be used to generate screen shots 900-1500. Process 1600 is automatic. It is noted that all the steps of process 1600 can be automated (e.g. by fuzzy logic ML) and then, optionally, corrected by a human expert to improve performance and increase output accuracy. Process 1600 can obtain digital images and then automatically generate a plurality of short digital videos (e.g. thirty seconds, etc.). These videos can be sent to various online websites (e.g. online social networks, etc.) where they can be automatically embedded in various contexts. These can include being integrated into a newsfeed, promotional videos, etc.

More specifically, in step 1602, process 1600 can enable a user to upload digital images of various views of a fashion item. In step 1604, process 1600 implements background removal processes. These can include ML-based processes to automatically make the background uniform and remove unwanted digital image effects beyond the borders of the fashion-item image. Accordingly, the digital images can have a constant background across the various views.

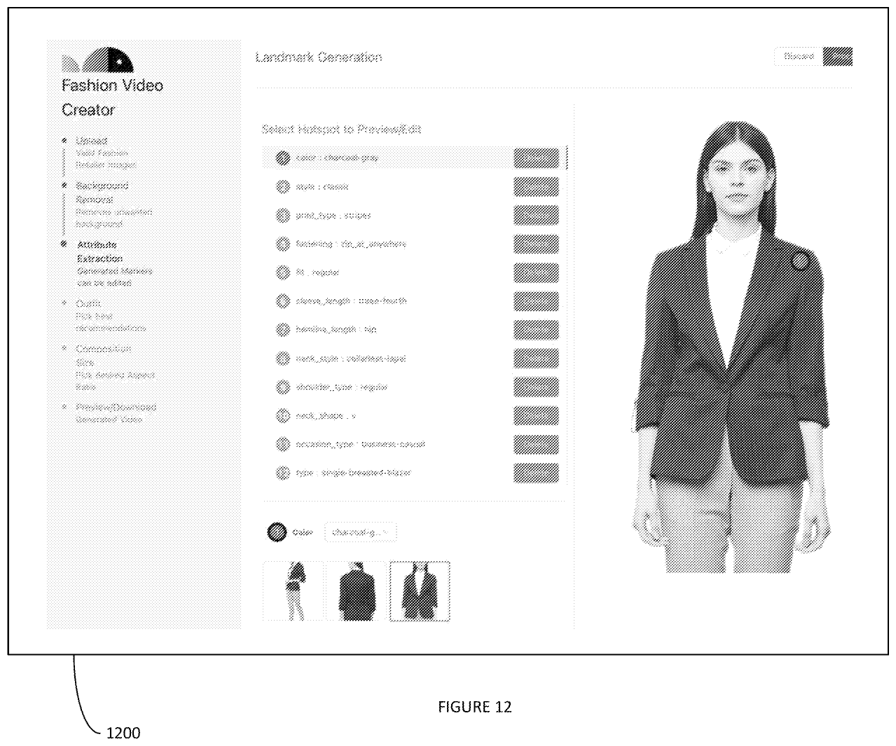

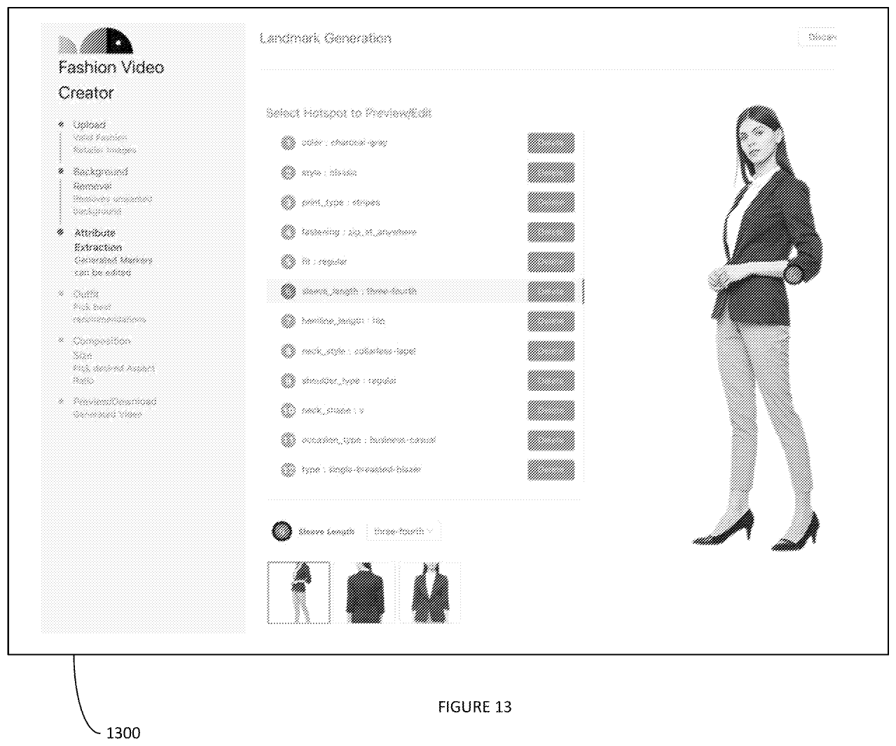

In step 1606, process 1600 implements attribute extraction. Generated markers (e.g. see FIGS. 12 and 13 supra) can be edited. Attributes can include, inter alia: style of garment, sleeve length, color, material, patterns (e.g. pin stripped, etc.), etc. The attributes automatically selected by step 1606 can be verified/updates by a human fashion expert and/or the user. Attributes can be selected based on an optimization algorithm that selects the best style types/attributes to highlight (e.g. based on ML learning). For example, for a diamond ring, carat value and the cut of the diamond would be highlighted while for a jacket, we will have the material and style as a highlighted feature. A virtual garment generation process can be used here as well. The virtual garment generation process can provide various styles to integrate into and/or add to the virtual garment being manipulated by process 1600. Accordingly, step 1606 can generate a ‘best version’ (e.g. based on ML processes and other inputs) of the fashion item.

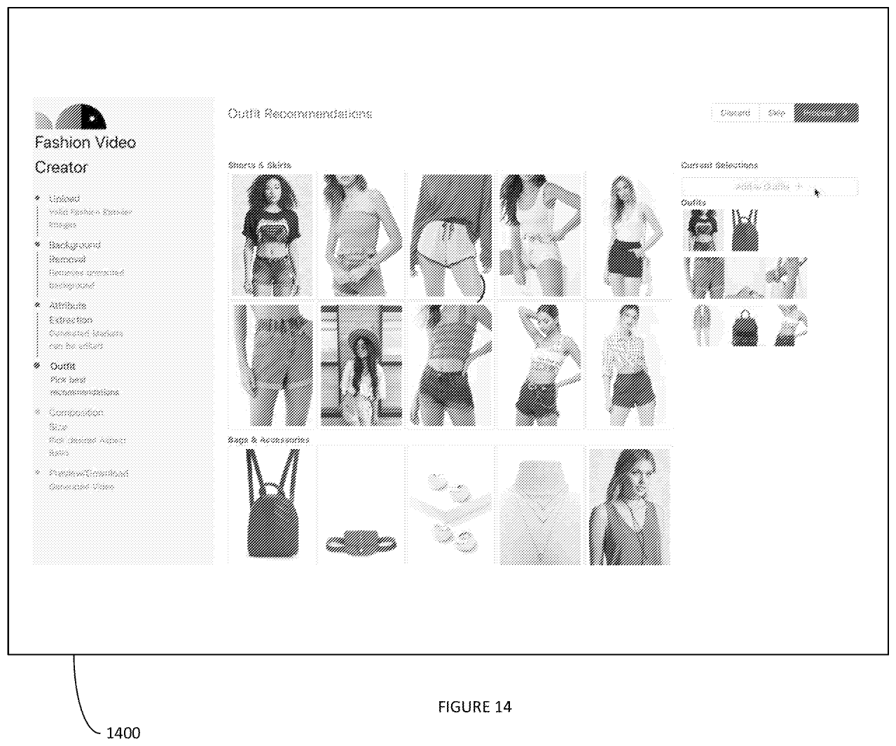

In step 1608, process 1600 implements outfit selection processes (e.g. see FIG. 14 supra). In step 1610, process 1600 implements composition selection processes. For example, a video aspect ratio can be selected.

In step 1612, process 1600 uses the output of the previous steps to automatically generate a video and/or a preview video. Process 1600 renders a stream where the video components are collected and show cased.

A template is a story or a narrative that describes a fashion item. For example, in the case of a ring, the story will be about the novelty of the material or the jewel used. Even in case of garments, there can be a story line which talks about how it can be worn in different seasons, there can be a story line which talks about how trendy the outfit is. There can also a story line which highlights the sustainability angle.

Each of the template would require images where the model either virtual or real human to be in a certain pose and to where a certain set of fashion items. These templates can be manually set or dynamically put together by a system too. Each template would be a combination of the steps showcased in the figures. Outfit selection process can be using multiple outfits either through machine learning models which are based on data or input by experts.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent is:

1. A method for an automated video generation from a set of digital images comprising:
obtaining the set of digital images, wherein the set of digital images represent a specified object to be showcased in an automatically generated video;
implementing pose identification on each view of the specified object in the set of digital images;
implementing a background removal operation to set a consistent background to each digital image;
implementing an image resolution increase operation on each digital image;
implementing an attribute extraction operation on each digital image using a set of image classifiers, wherein the set of image classifiers are run on each digital image to generate one or more textual tags, wherein the one or more textual tags are integrated in the automatically generated video;
implement an attention map generation, where an attention map comprises a visualization of the specified object produced by a deep-learning algorithm that determines a most influential part of each digital image, wherein a predicted tag specifying the most influential part each digital image, where each attention maps is used in the automatically generated video to zoom into specific areas of the object;
implementing an outfit generation of a collage of images of the specified object with other objects, wherein the collage of images is included in the automatically generated video to show various combinations of the specified object and other object;
generating a rendering of the automatically generated video comprising the set of digital images with the consistent background, an increased resolution, the one or more contextual tags, one or more zooms into specified areas a specified object and the collage of images.

2. The method of step 1, wherein the step of implementing pose identification on each view of the specified object in the set of digital images further comprises:
given each digital image, determining that the digital image comprises a front pose of the specified object, a side pose of the specified object or flat shot of the specified object.

3. The method of claim 3 further comprising:
based on the type of pose, selecting a corresponding pre-generated video template.

4. The method of claim 1, wherein the contextual tags are used to show a detail n a of the specified object.

5. The method of claim 4, wherein the contextual tags are used to highlight a unique features of the specified object.

6. The method of claim 1, wherein a collage image generator is used to minimize any white space between the specified object and the other objects.

7. The method of claim 1 further comprising:
automatically providing a relevant audio file as a background score of the automatically generated video, wherein the audio file selected by a deep learning machine learning algorithm based an aesthetic attribute of the specified object.

8. The method of claim 1 further comprising:
integrating one or ore hooks to the other objects presented in the video, where a hook comprises a hyperlinks.

9. The method of claim 1, wherein the specified object comprises a fashion item.

10. The method of claim 9, wherein the fashion item comprises a jacket, a dress, a shirt, or a purse.

11. The method of claim 10, wherein the other objects comprise a plurality of other fashion items relevant to the type of the fashion item.

12. The method of claim 11 further comprising:
providing a dashboard that enables a subject matter expert to correct various aspects of the automatically generated video.

13. A method of automated product video generation comprising:
receiving a set of uploaded digital images comprising a set of views of a fashion item;
implementing a machine-learning based background removal process to automatically make the background uniform and remove unwanted digital image effects beyond a border of each digital image of the fashion-item image;
implementing an attribute extraction process to generate a set of markers, wherein each marker identifies an attribute of the fashion item;
using a machine learning algorithm to generate a best version of the fashion item;
implementing a composition selection processes comprising selecting a video aspect ratio of the automatically generated video;
automatically generating a video comprising the set of digital images of the fashion item with the uniform background, the selected aspect ration, the selected outfit, and the set of markers.

14. The method of claim 13, wherein the attribute of the fashion item comprises a style of the fashion item, a sleeve length of the fashion item, a color of the fashion item, a material of the fashion item, or a patterns of the fashion item.

15. The method of claim 14, wherein the set of markers are located in the video to point to the attribute of the fashion item.
